(19) United States
(12) Patent Application Publication
(10) Pub. No.: US 2023/0325953 A1
(43) Pub. Date: Oct. 12, 2023

(54) METHOD AND SYSTEM FOR OPTIMIZED POSTSECONDARY EDUCATION ENROLLMENT SERVICES

(71) Applicant: Arizona Board of Regents on Behalf of Northern Arizona University, Flagstaff, AZ (US)

(72) Inventors: Steven BURRELL, Flagstaff, AZ (US); Jose Luis CRUZ RIVERA, Flagstaff, AZ (US); Chad Arthur EICKHOFF, Flagstaff, AZ (US); John GEORGAS, Flagstaff, AZ (US); Ann Marie P. DEWEES, Flagstaff, AZ (US); Michelle PARKER, Flagstaff, AZ (US); Margot SALTONSTALL, Flagstaff, AZ (US)

(21) Appl. No.: 18/132,240

(22) Filed: Apr. 7, 2023

Related U.S. Application Data
(60) Provisional application No. 63/328,597, filed on Apr. 7, 2022.

(51) Int. Cl. G06Q 50/20

(52) U.S. Cl. CPC G06Q 50/2053

(57) ABSTRACT

A method and system for training and applying at least two neural networks for matching prospective students to institutions is disclosed This method and system enhances access to high-quality, affordable postsecondary education by predicting the likelihood of success that a given student will have at an institution. This is accomplished by predicting the similarity between a student and institution alumni on both objective and subjective criteria.

### FIELD

This application claims the benefit of priority to U.S. Provisional Patent Application No. 63/328,597, filed under the same title on Apr. 7, 2022, the entire contents of which are incorporated by reference herein for all purposes.

### BACKGROUND

A postsecondary education is essential for upward social and economic mobility. Most postsecondary institutions, including more than three-quarters of public and private non-profit institutions, put students on a path to earn more than a high school graduate and to recoup their total investment within 10 years of entry. Furthermore, research suggests that the sustained economic prosperity of the United States depends upon implementing policies and practices that will ensure all prospective students—regardless of race, ethnicity or socioeconomic status—have equitable access and support to complete quality, affordable credentials that offer economic mobility.

Hence, there is an urgent need to create the conditions that will allow more prospective students to gain access to postsecondary educational programs that will lead to degrees and credentials with market-value. But it has been nearly 15 years since the nation publicly prioritized college completion as a means to improve economic competitiveness, and nearly 25 years since the Commission on the Future of Higher Education called on the United States to “address the needs of higher education in order to maintain social mobility and a high standard of living.” Since then, educational attainment and social mobility goals have been widely embraced, and many educational organizations and policymakers have made them central tenets of their reform agendas.

Unfortunately, the state of higher education in America is still not as strong as it could and should be. Student-loan debt has surpassed the $1 trillion mark and is now higher than automobile and credit-card debt. Persistently low degree-completion rates, particularly among low-income students and students of color, continue to limit social mobility and, in the process, threaten our nation's competitiveness. By age 24, for example, young people from families in the bottom income quartile are seven times less likely to have a bachelor's degree than those from families in the top quartile, and the United States ranks near the bottom in the developed world in the educational attainment of young people when compared against that of their parents.

One of the obstacles to increasing educational attainment is the difficulty that prospective students face when researching postsecondary programs that would be a good fit for them from the perspective of preparation, affordability, and post-graduation economic outcomes. Another is the difficulty of students gaining access to their programs of choice and getting the financial, academic, and other services they need to complete their programs in a timely manner. As a result, prospective students can become frustrated and give up on their postsecondary educational goals, or worse, they succumb to the high-pressure, predatory recruitment practices of some bad actors—enrolling in postsecondary programs with low graduation rates, high student loan debt levels, and disappointing post-graduation outcomes for the few that actually complete.

These obstacles are also mirrored for postsecondary institutions that struggle to meet enrollment targets to remain financially viable and providing access to students with the ability to benefit from the programs and services they can offer. Small private colleges are closing due to low enrollment (e.g., Holy Names and Cazenovia just this year)—a trend that is projected to accelerate. This situation is complicated by competitive forces such as relatively inexpensive online educational resources, many of which are free, and the use of sorting mechanisms by prospective employers other than a completed four-year degree. In short, the perceived value of college to prospective students may be dropping, and indeed, college enrollment steadily decreased from 2019 through 2022, and has not bounced back to pre-COVID levels. As a result, postsecondary program providers spend much on marketing and recruiting of students, diverting funds that could otherwise be invested to improve the quality of educational programs and student support services. The cost of converting a prospective student who has expressed interest in a program through an online search result into an enrolled student is measured in thousands of dollars.

Meanwhile, many employers struggle with recruiting and maintaining a high-quality workforce. Even in instances where the size of the regional population suggests they could meet their needs if it weren't for low educational attainment and the mismatch between workforce needs and the skills of the population in the region.

To tackle some of these obstacles, actors in the public and private sector have worked to strengthen the information available to prospective students about the choices available to them, simplify the applications process for access to postsecondary programs as well as financial aid, and developed predictive analytics tools to help institutions better understand the needs of their students, among other solutions. These existing systems generally rely on correlating academic data of prospective students (i.e., standardized test scores, high school grades) with setpoints identified by the institutions, or to similar metrics held by students who enrolled in the institutions in the past.

These existing systems have certain disadvantages. For example, existing systems that match students on the basis of academic similarity to previous students tend to freeze an institution's student body profile, preventing evolution and possibly limiting diversity. Additionally, these existing systems fail to incorporate important data reflecting student demographics, and especially, student sentiment, values and emotions. Such data sources are critical because a student's college experience, and even a “successful” college experience, does not depend entirely, or even mostly, on their academic fit to the institution. Instead, prospective students are increasingly motivated by experiential values: is the institution friendly, does the student feel a sense of belonging, do the institution's social values match those of the student, etc. Existing systems fail to capture these values, which limits the ability of those systems to predict “fit” on a holistic basis. Additionally, existing systems generally rely on academic performance data provided by institutions. This source of data is limited because the academic performance of a student, measured at the time of graduation, does not measure the value that a college experience may have when evaluated from the standpoint of a person several years-post graduation.

Therefore, there is a need in the art for improved systems capable of matching the fit between prospective students and institutions on a holistic basis, that captures emotional, sentiment and values, as well as academic and demographic measures.

### SUMMARY

The status quo shortcomings described above may be addressed by implementing the methods and systems described herein. In one embodiment, a system is provided that includes an online platform directed to brokering relationships between prospective postsecondary students, postsecondary education service providers, enrollment management vendors and professionals, and other third-party public and private data, content, and service providers in the postsecondary education space. The disclosed system establishes an efficient marketplace for prospective students, education service providers or institutions (referred to herein as “service providers” or “institutions”), and third parties by serving as an aggregator of qualified and vetted leads (i.e, prospective students) for postsecondary education service providers. Additionally, the system may serve as a value-added admissions concierge for prospective students, by conveying information to the student relevant to the student's desires and personal profile. Additionally, the system may serve as a communications conduit between service provider admissions offices and the student usable to, for example, convey offers of admission or conditional offers.

In certain embodiments, the invention is directed to identifying one or more matches between a student and one or more service providers, a match indicating, generally, a good fit between the student and a service provider or an educational program offered by the service provider. A match is determined in accordance with a matching algorithm, and specifically, in an application server realized by one or more computing devices, processes being executed on one or more computing devices, virtual computing devices or some combination of the foregoing. The matching algorithm takes as one input student data. The matching algorithm takes as another input service provider data. The matching algorithm then matches the student and the service provider on the basis of comparing the student data and the service provider data.

In one embodiment, the student data includes data supplied by the student, student data that is generated or hosted by third parties, or some combination of the two. Examples of student-supplied student data may include student identifying information, demographic and financial information, geographical information, and information relating to the student's desires, goals and constraints regarding a program of academic study and lifestyle issues like housing options. Examples of third party student data may include geographic information about the student, student access machine IP information, tax information, information from primary, secondary or community educational institutions, military or public service organization service records, information that a student has voluntarily provided to third parties, such as a Linkedin profile or social media history, or some combination of the foregoing. In certain embodiments, student data, and in particular, student-supplied student data, may be classified according to one or more levels (e.g., basic, basic plus, and premium), reflecting a level of detail about the student and corresponding to a level of service that the student is to receive from the system.

In certain embodiments, student data is gathered using a prospective student facing user interface. The student facing UI provides an interface by which a prospective student may supply student data to the system, and receive from the system messages, including messages indicating a match to one or more institutions. The prospective student-facing UI may include an artificial intelligence interview bot (“AIIB”)—an automated process that may include a question tree and a natural language processing engine for evaluating and categorizing responses and navigating the question tree. The student-facing user interface may gather demographic, academic, financial, housing preferences and other information of the sort discussed above. Additionally, the prospective student facing UI gathers, in some embodiments, subjective sentiment data from the student relating to their aspirational experiential goals for college (and beyond) and personal values. Examples of this sentiment data may include degree to which the student values being accepted, feelings of belonging, having an active social life, meeting people who are like them, meeting people who are different, feeling connected to peers, feeling connected and having interactions with mentors, feelings of safety, general feelings of optimism or pessimism regarding college, being part of a community, growing as a person, feeling respected, validated and valued, etc. These data may be gathered from the prospective student by any of a number of methods, including, by asking the prospective student to select a predetermined number of subjective sentiment categories on a binary basis (e.g., by checking radio buttons or verbally replying “yes” to an AI chat bot). Preferably, the prospective student is asked to rank the strength of preference for the subjective sentiments on a scale. The same ranking data may also be obtained from the prospective student for objective criteria (e.g., measuring the importance of certain degree programs, the importance of getting a well-paying job after graduation, the importance of graduating within 4 years, etc.).

Additionally, in an embodiment, the system receives service provider or institution data. The service provider data may be received from a participating service provider (e.g., an institution such as a university), or from third party sources, such as data aggregators or third-party publications. Examples of service provider data may include the identifying information about the provider, available courses of study, data regarding tuition, fees and costs, data relating to the availability of various educational modalities (e.g., in-person versus virtual/remote), data relating to desired student profiles, i.e., desired student demographic data or desired enrollment in certain courses of study, data relating to historic student performance as a function of student demography and course of study (e.g., first year average grades, average degree completion timelines and graduation rates), and historical data regarding post-degree performance (e.g., historical data regarding early career salaries for holders of various degrees.)

In preferred environments, the system receives a third data set from institution alumni (e.g., students who have graduated or employees who have left a firm). The system includes an alumni facing UI, which also may include an AIIB The alumni facing UI gathers data from alumni regarding previous objective and subjective data points related to their college experience. Objective data points would include data such as whether the alumnus graduated, years to graduation, whether the alumnus graduated in his/her initially chosen major, GPA, any honors awarded, months until first job, whether the first job was related to the alumnus' major, and annual income. Additionally, in a preferred embodiment, the alumni facing UI gathers retrospective subjective sentiment data in categories related to the categories for which sentiment data is gathered from prospective students. For example, the alumni facing UI may gather data on whether and the degree to which an alumnus felt welcomed, supported, built meaningful relationships, made meaningful connections with faculty and mentors, made their families proud, had fun, felt connected to the campus community, felt valued/respected/validated, grew as a person, etc., as a result of their college experience.

In certain embodiments, student data is compared to service provider data, and a first match score is computed, where the match score reflects a degree of correspondence between the student data and a particular institution. For example, a student may provide data indicating an interest in studying electrical engineering, on a remote basis, with an in-person lab component, at a school within some radius of the student's location, below a certain budget. The system may search provider data and identify a list of providers for which the provider data indicates that the providers can match these criteria. If a match is identified, the system may take one or more action steps. For example, the system may issue a message to a service provider indicating a match with a particular student (i.e., a “lead”). The match message may include student-identifying information, or anonymized or partially anonymized information about the student. The message may also include a means for contacting the student, for example, the student's contact information, or a link to anonymized student email address for an email service hosted by the system. The service provider may then reach out to the student in order to begin a discussion about enrollment and further exchange of information.

In alternative embodiments, if a match is detected, the system may send the student with a list of matching service providers. The message may contain contact information for the service provider, or a token usable to contact the service provider. The token may include an identifier enabling a service provider that has been contacted to review the match parameters and student data that resulted in the match. The token may be, for example, a QR code, hyperlink, or code that that is appended to a student email to the service provider that the service provider may use to retrieve student data or data relating to the match process from the system.

In certain embodiments, the matching algorithm may compute a match score or match index on the basis of comparison of student and provider data within individual categories. This procedure may involve the computation of match sub-scores directed to areas such as budget/finances, program of study, educational modality, lifestyle/housing issues, and post-education job prospects or average salary information. The matching algorithms may then compute sub-match scores for the sub-categories by comparing student data and provider data within each sub-category. The matching algorithm may then compute a composite match score on the basis of the sub-match scores. This may as simple as computing an average or sum of sub-match scores, but in preferred embodiments, weights are applied to the sub-match scores before an overall match score is calculated.

For example, as part of an enrollment process, a student may be prompted to rank various sub-categories of information in terms of importance to the student. For example, the student may place a high rank on the budget category, but a low rank on the availability of on-campus housing. Those ranks may be applied to increase or decrease the contribution made by a particular category to the overall match score. Similarly, a service provider may provide rankings corresponding to the same categories. For example, a service provider may downrank the “budget” category if it is confident that can provide financial assistance to a student at any budget level or can otherwise be flexible on tuition and fees. A service provider may uprank certain categories based in the importance of a match within that category to the service provider. These preferences may be based on historic data collected by the service provider that indicates that matches within certain categories are more highly correlated to successful student outcomes.

In certain embodiments, the matching algorithm can respond to machine learning training from historical data relating to students, former students and alumni who have used the system and data reflecting their experience with a service provider at which they enrolled. For example, the system may receive from service providers historical data regarding the educational experience of students who have used the system in the past. Such data may include, for example, information on grades, class rank, time to degree completion, graduation rate, any honors achieved, disciplinary information, and information on indebtedness at graduation. Such data may be anonymized. This historical student experience data may be used, as a general matter, to attempt to generate matches with new students who resemble students who had a successful experience with the service provider previously. One method of accomplishing this the use of neural network having a weighted connection fabric between an array of input nodes reflecting student data types, and an array of one or more output nodes reflecting student outcomes. The network can be trained by inputting historical student data of the various types and adjusting node weight until the network reflects a matrix of historical success metrics for that student. This process can be repeated for additional students, and the node weights averaged across the entire student population. The resulting weighted network may then be usable to determine a match by applying new student data to the network, and reviewing the network's prediction of student success.

The various data (institution, prospective student and alumni) may be used by various embodying systems in various ways. At base, a goal of the system is match institutions and prospective students by computing one or more matching scores based on the similarity between a prospective student and a successful alumnus. The result of this process is a composite matching index or propensity score reflecting a degree of fit or compatibility between a student and institution. Institutions with matching scores above some predetermined threshold may be presented to a student as a matches, and students with matching scores above some predetermined threshold may be presented to an institution as matches.

As part of this matching process, in certain embodiments, hard or relatively inflexible student and institution criteria are accounted for. Thus, in one embodiment, in a first matching step, an institution (or a student) may be qualified or disqualified on the basis of inflexible or criteria that are highly rated by the student or institution (e.g., location, institution size, budget, availability of certain degree programs, GPA test score cutoffs, etc.). The result of this first step is the qualification of a pool of students or institutions that match on the most basic criteria—criteria without which the student would never attend (or be admitted to) the institution under most circumstances. This first step may be referred to herein as a “simple match”, and it should be conceptualized as matching on the most fundamental attributes of the students and institutions.

In a second step, matching is conducted on a second, more specific collection of student data that is used to identify similarity between prospective students and successful alumni of each institution being matched (i.e., each institution that the first step identified as being within the realm of possibility on the basis of fixed or inflexible criteria). This second matching step is based on objective student data other than the emotional sentiment data that will be described below. The objective student data may include objective student demographic data such as family or individual wealth or income, GPA, test scores, racial/ethnic/sex identity, domicile, and desired major. The result of the second matching step is the generation of an objective propensity score that reflects the similarity of a prospective student to successful alumni of an institution on the basis of one or more pieces of objective student data such as the ones previously mentioned. The second matching step accomplishes this by supplying an input array of student data to a trained AI (“artificial intelligence”) model, which may be a trained artificial neural network. In certain embodiments, the AI model has been trained on input data gathered from objective alumni data who successfully completed degree programs at the institution, or who are otherwise classified as successful enrollees.

In certain embodiments, the second matching step may be used to winnow down the initially collected list of prospective institutions by excluding institutions that have an objective propensity score for a student that is below some threshold. Similarly, institutions using the system may exclude candidates having an objective propensity score above some predetermined threshold.

In a further embodiment, the system implements a third, further matching step. The third matching step matches prospective students to institutions on the basis of similarity with alumni in terms of subjective sentiment data. This third matching step is based on subjective sentiment data collected from prospective students on subjects such values, aspirations regarding personal growth, emotional state and growth, and other sentiments. The result of the third matching step is the generation of an subjective propensity score that reflects the similarity, in terms of subjective sentiments, of a prospective student to successful alumni of an institution on the basis of one or more pieces of subjective student data such as the ones previously mentioned. The third matching step accomplishes this by supplying an input array of student sentiment to a trained AI (“artificial intelligence”) model, which may be a trained neural network. In certain embodiments, the AI model has been trained on input data gathered from alumni who successfully completed degree programs at the institution, or who are otherwise classified as successful enrollees.

In certain embodiments, the subjective propensity or match score may be used as a substitute for or to supplement the objective propensity score in a number of ways. For example, a match between a student and an institution may be determined if an average or some other composite of the two scores exceeds some threshold. In alternative embodiments, a student may be shown a list of institutions for which they have a high objective propensity score, and then institutions on that list for which they have a high subjective propensity score may be highlighted. Additionally, or alternatively, communication channels may be opened between student and institution on the basis of a high subjective propensity score. Additionally, institutions can be dropped from a match list, despite a high objective propensity score, if the subjective propensity score for a student is below some threshold.

In certain embodiments, the system may provide or facilitate the provision of additional services and information to participating students. For example, in a preferred embodiment, a student may provide a higher level or more detailed student data (for example, subjective sentiment data). This data may be packaged as a lead and sent to service providers for review. This step may be taken in response to an initial evaluation of a match between the student data and provider data on the basis of comparing student data (e.g., objective data) with provider data previously supplied by one or providers. In response to the lead, providers may examine the student data, evaluate the fit of the student, and provide the student with additional information about the provider. In the event of an apparently good match, the provider may send to the student an offer of admission, a conditional offer of admission, an offer of financial aid, an offer to assist with applying for financial aid with the service provider or filling out a FAFSA, or some combination of the foregoing.

In certain preferred embodiments, the invention includes a method for determining a match or good fit between a student and an institution, and in particular, methods and systems for determining and displaying matches between an institution and a prospective student. The method includes causing a first user interface to be presented to a prospective student of the institution via a first computing device, the first user interface employing an artificial intelligence interview bot configured to elicit inflexible institution criteria, objective student data about the prospective student and subjective student data about the prospective student's sentiments toward values and experiences relating to the institution. The method also includes receiving institution data over a network. The method also includes building an institution model from the institution data, the institution model reflecting objective institution data, and applying the inflexible institution criteria to the institution model, and on the basis of the application, qualifying the institution for a possible match. The method also involves, in a first matching process, using a first AI model including an artificial neural network to determine the similarity of the objective student data to objective alumni data previously received from successful alumni of the institution, and on the basis of the determined similarity and computing an objective matching index. Additionally, the method includes, in a second matching process, using a second AI model including an artificial neural network determine the similarity of the subjective student data with subjective alumni information previously received from successful alumni of the institution, and on the basis of the determined similarity, computing a subjective matching index. According to the method, a match criteria is to the subjective and objective matching indices, and determining whether the student is a match to the institution on the basis of the application. If the student is a match to the institution, the method causes the first user interface to display an indication of the match to the prospective student.

Inventive embodiments also include a computing system having a programmable processor and memory or data storage encoding computer executable instructions operable to cause the computing system to execute the forgoing method steps.

The systems summarized above address status quo shortcomings by providing, in one embodiment, an online platform directed to brokering relationships between prospective postsecondary students, postsecondary education service providers, enrollment management vendors and professionals, and other third-party public and private data, content, and service providers in the postsecondary education space. The system disclosed herein establishes an efficient marketplace for prospective students, education service providers, and third parties by serving as an aggregator of qualified and vetted leads (i.e, prospective students) for postsecondary education service providers. Additionally, the system may serve as a value-added admissions concierge for prospective students. Inventive embodiments have the ability to optimally connect a prospective student to a postsecondary service provider so as to maximize the likelihood that both the institution and the student will achieve economic value from the relationship. To this end, the present invention comprises a series of end-to-end services and methods built on top of the system architecture that enables this objective to be met. Critically, systems operating according to inventive embodiments may provide deep and authentic matching between individuals and institutions based on both objective and subjective sentiment data.

Additional features and advantages of the inventive embodiments will be clear upon review of the following detailed description.

### BRIEF DESCRIPTION OF THE DRAWINGS

Aspects of the disclosure will be better understood after reading the following description when considered with the drawings in which:

FIG. 1 is a conceptual block diagram illustrating an example of a hardware implementation for an online computer system 100, usable to realize an embodying student-provider matching system;

FIG. 2 is a flowchart showing data collection and matching model building steps of a method implemented by an embodying system;

FIG. 3 is a flowchart showing matching steps according to an embodiment;

FIGS. 4A and 4B schematically depict the operation of an artificial neural network usable in connection with inventive embodiments;

FIG. 5 is a conceptual block diagram of a multilayer ANN usable as an AI model in connection with the disclosed embodiments;

FIG. 6 is a flowchart showing a training method usable to train an ANN usable as an AI model in connection with the disclosed embodiments;

FIG. 7 is a conceptual block diagram of an embodying matching system incorporating a matching engine including potential employer input.

### DETAILED DESCRIPTION OF THE PREFERRED EMBODIMENTS

Embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

While the terms “students”, “prospective students”, “alumni”, “institutions” and “service providers” are used below to refer generally to prospective enrollees at post-secondary institutions, post-secondary institutions, and graduates of post-secondary institutions, the embodiments and concepts described herein are more broadly applicable to other situations in which matching individuals to institutions is desirable. For example, the systems described below may be used by employers, pre-secondary institutions (e.g., prep schools), military organizations, government organizations, political or volunteer institutions, etc. Additionally, while the example systems and methods below refer generally to “alumni” or “successful alumni”, they are not so limited. While in certain cases “alumni” refers to an individual who has successfully completed a degree program at an institution, that term may also refer to people who completed some other credential or certification program. Additionally, “successful alumni”, as that term is used below, need not be limited to individuals who earn degrees. Individuals who earn other achievements, such as credentials or certificates may also be referred to by this term.

This disclosure is directed to an improvement in pre-existing systems for matching candidates and institutions, by providing at least two distinct, separately trained AI models for calculation of a match—a first model based on objective criteria, and a second model based on subjective criteria. Application of these models is optionally but preferrably preceded by a sorting algorithm that identifies candidate individuals or institutions from a wider pool. The match determinations interact in various ways to be described to result in an assessment of a fit level between a prospective student for post-secondary education and a post-secondary school or program (“service provider”). While the bulk of the examples presented below are described in the context of students and educational institutions, it will be appreciated that the methods discussed herein may be extended to other contexts, such as matching between prospective employees and employers.

Generally, embodying systems are directed to a cascading matching process in which, in a first process, candidate institutions or students are screened on a binary, go/no-go basis on the basis of inflexible criteria. In a second process, students are matched to the remaining institutions by a first AI model that gauges the similarity of students to graduated alumni on the basis of objective student and alumni data. In a third process, students are matched to institutions by a second AI model that gauges the similarity of students to graduated alumni on the basis of subjective student and alumni sentiment data. The result of these processes is a pair of propensity scores or match indices, which may be used, separately or in combination, to match students to institutions or initiate other processes such as communication and reporting processes between the parties. For example, the system may facilitate a connection between the student and one or more service providers if the determined degree of match exceeds some pre-set or variable threshold on the basis of one or some composite of the match indices.

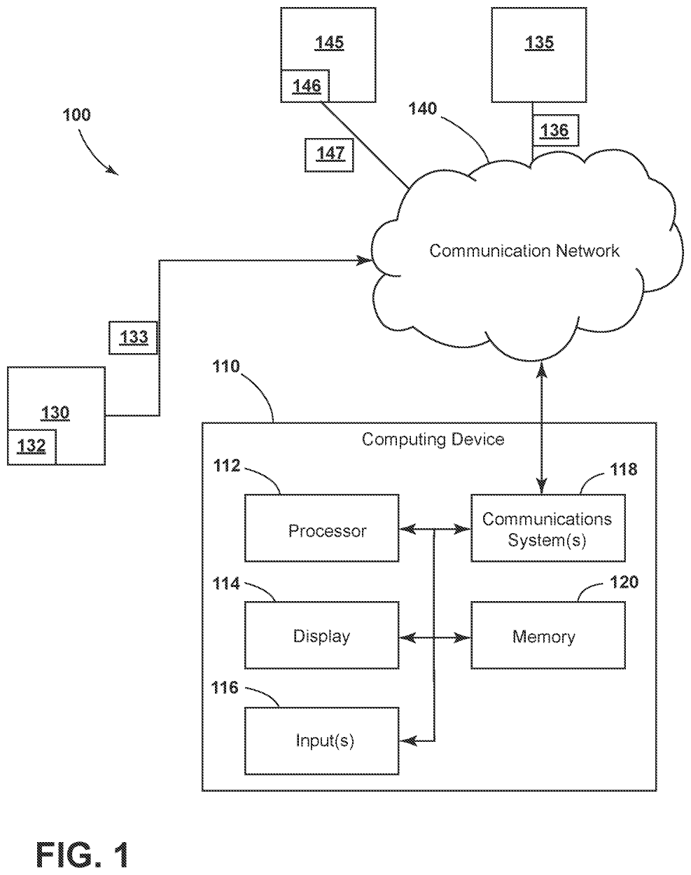

FIG. 1 shows an example 100 of a system for matching candidates to institutions in accordance with some embodiments of this disclosure. As shown in FIG. 1, a computing device 110 can receive and process student data 130 in one or more matching processes applying one or more matching models. In a preferred embodiment, the matching models are AI models, including at least a first and a second AI model. The matching models are encoded in and applied in accordance with computer executable instructions stored in memory 120, which may be volatile or non-volatile, and local or cloud based. Preferably the first and second AI models are trained neural networks that have been configured to detect the similarity between input data vectors and previously presented input data vectors on which the neural networks have been trained.

In the system of FIG. 1, the computing device 110 can electronically communicate with a number of data sources and/or system users (e.g., students 130, alumni 145 and third party data providers 135) to receive a variety of previously stored and contemporaneously generated data (e.g., student data 133, alumni data 147, and third party data 136) over a communication network 140. Computing device 110 may also communicate information to one or more of these entities over the same communication network. Here, students 130, alumni 145 and third party data provider 135 are presented as examples of entities with which the system can communicate to gather student, alumni or third party data (i.e., institution data), but communication with other entities (i.e., multiple students, other third parties, data vendors or aggregators, etc.,) is possible. Students 130, alumni 145 and third party data provider 135 may be individual users of the systems, computing devices being used by users, or some combination of these. In cases where these third party data sources are computing devices, they may be constituted with the general purpose features of computing device 110 described herein. They may also exist in a client-server relationship with computing device 110.

In a preferred arrangement, a student supplies student data 133 to the system (i.e., to computing device 110) through a student facing user interface (UI) 132. The student facing UI 132 may be generated by an application running on the student's computing device, or it may be a web app running from computing device 110. Preferably, the student facing UI is, or is supplemented by an artificial intelligence interview bot (“ABB”)—an automated process that may include a question tree (i.e., a script) and a natural language processing engine for evaluating and categorizing responses and navigating the question tree. Student data may be communicated anonymously, for example, with a unique identity token that is stored at the system computing device 110 (e.g., in database 120) in association with the student data. It is contemplated that the student facing UI may be generated by an application running at a computing device local to the student, or it may be a web-based or cloud-based application being generated by computing system 110.

Similarly, alumni 145 supply alumni data 147 through an alumni facing UI 146, which again may be generated by an application running on the alumnus' computing device, or it may be a web app running from computing device 110. Preferably, the alumni facing UI is, or is supplemented by an artificial intelligence interview bot (“ABB”)—an automated process that may include a question tree (i.e., a script) and a natural language processing engine for evaluating and categorizing responses and navigating the question tree. Additionally, third parties 135 supply third party data 136 to computing device over the communication network. The third party data is generally institution data, for example, data about the size, degree programs, cost, graduation rate, admission criteria, location, employment statistics, inflexible admission criteria, and other objective data about one or more institutions. These data may be supplied by institutions themselves, or may be sourced from third party vendors, aggregators or other data stores.

In certain cases, embodying systems such as system 100 are implemented by a single institution to match prospective students. In such cases, institution data is generally sourced internally, and a connection to an outside data provider is unnecessary. More generally, however, embodiment systems serve as clearing houses between multiple institutions and a student pool, and in such cases, institution data will generally be sourced from third parties and institutions.

In some examples, the communication network 140 can be any suitable communication network or combination of communication networks. For example, the communication network 140 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 140 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

In the system 100 of FIG. 1, the computing device 110 can be any suitable computing device or combination of devices, such as a desktop computer, a laptop computer, a smartphone, a tablet computer, a server computer, or a virtual machine being executed by a physical computing device, etc. In some examples, the computing device 110 can train and/or run the first AI model (the objective AI model) and the second AI model (the subjective AI model), and any additional AI models described herein. In other embodiments, different computing devices can divide the aforementioned training and execution steps. In further examples, the computing device 110 can include a first computing device for the first AI model, a second computing device for the second AI model, and additional computing devices for other AI models to be described. It should be appreciated that the training phase and the runtime phase of any combination of the first AI model, the second AI model, and any other AI models can be separately or jointly processed in the computing device 110 (including physically separated one or more computing devices). Although the system described here references two AI models (first, and second), alternative realizations of the system could be in the form of a sequence of one or more AI models or a hierarchy of AI models for determining matching.

In further examples, the computing device 110 can include a processor 112, a display 114, one or more inputs 116, one or more communication systems 118, and/or memory 120. In some embodiments, the processor 112 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc. In some embodiments, the display 114 can include any suitable display devices, such as a computer monitor, a touchscreen, a television, an infotainment screen, etc. In some embodiments, the input(s) 116 can include any suitable input devices and/or sensors that can be used to receive user input, such as a keyboard, a mouse, a touchscreen, a microphone, etc.

In further examples, the communications system(s) 118 can include any suitable hardware, firmware, and/or software for communicating information over communication network 140 and/or any other suitable communication networks. For example, the communications system(s) 118 can include one or more transceivers, one or more communication chips and/or chip sets, etc. In a more particular example, the communications system(s) 118 can include hardware, firmware and/or software that can be used to establish a Wi-Fi connection, a Bluetooth connection, a cellular connection, an Ethernet connection, etc.

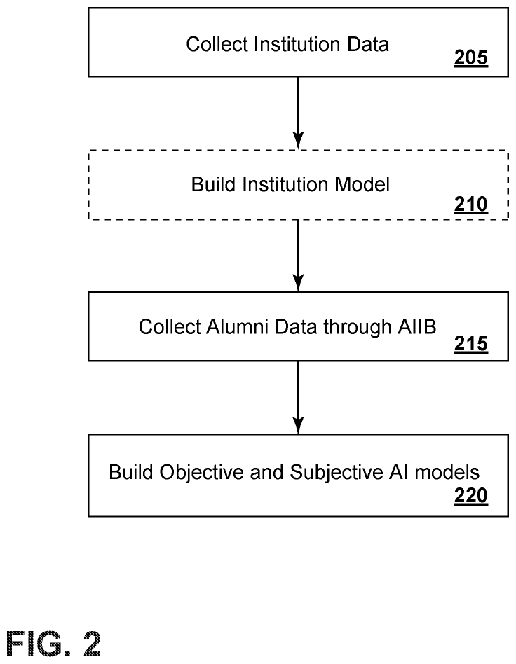

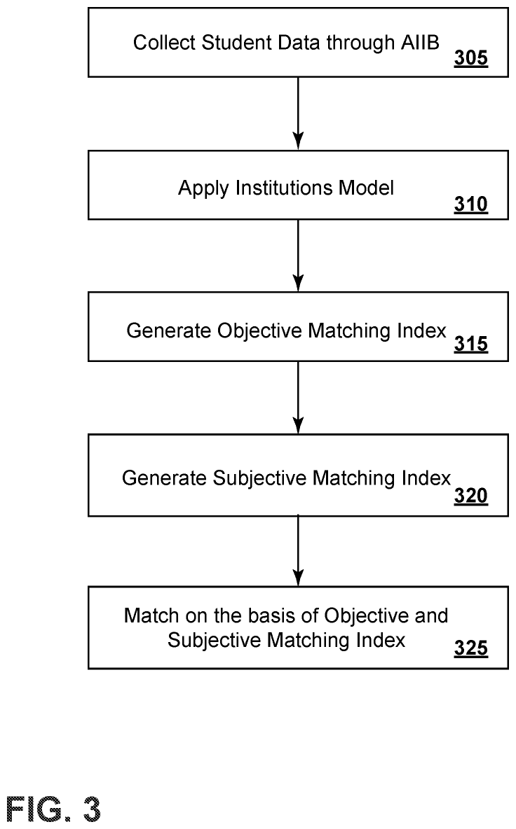

In further examples, the memory 120 can include any suitable storage device or devices that can be used to data, instructions, values, AI models, etc., that can be used, for example, by the processor 112 to compare student, institution and alumni data. The memory 120 can include any suitable volatile memory, non-volatile memory, storage, or any suitable combination thereof. For example, memory 120 can include random access memory (RAM), read-only memory (ROM), electronically-erasable programmable read-only memory (EEPROM), one or more flash drives, one or more hard disks, one or more solid state drives, one or more optical drives, etc. In some embodiments, the memory 120 can have encoded thereon a computer program for controlling operation of computing device 110. For example, in such embodiments, the processor 112 can execute at least a portion of the computer program to perform one or more data processing and identification tasks described herein and/or to train/run AI models based on student, alumni and institution data described herein, present content to the display 114, transmit/receive information via the communications system(s) 118, etc. As another example, processor 112 can execute at least a portion of processes described below in connection with FIGS. 2-3.

FIG. 2 is a flow chart showing the steps of building one or more models usable to match prospective students against institutions. The FIG. 2 process begins (205) with collection and receipt of institution data. Institution data is generally objective information about an institution that might be useful to students as part of their application process for evaluating an institution. Institution data may be sourced directly from institutions participating in the system, from third party vendors, and/or from publicly available sources. In certain cases, institutions may be interviewed, for example with an AIIB, to generate institution data. Example third party sources include: IPEDs, USDOE College Scorecard, College Results Online, Social Mobility Indices, Labor Wage Data, Bureau of Labor Statistics, Job Portals, etc. Institution data categories include: size, tuition and fees, location, public/private status, percent of students receiving financial aid, average net cost after financial aid, available programs of study, admission criteria, available student support services, data regarding available cultural offerings, graduation rates by degree, data regarding transfer credits the institution accepts, the modality of programs (i.e., in-person or online), completion rates, expected loan debt, expected monthly payment on loan debt, non-degree certifications available, types of jobs that programs will prepare a student for, percent of graduates who are employed at various periods after graduation, sliced by degree or degree type, student demographics, faculty demographics, data regarding availability of on-campus housing, data regarding institution competitive and intramural athletic programs, median earnings at various time periods after earning a degree or credential. While the exemplary and simplified process illustrated in FIG. 2 is directed to building matching models for a single institution, it should be understood that, in preferred arrangements, models are built for each institution participating in the system.

At step 210, the system builds an institution model on the basis of the institution data. The institution model is a set of rules or preconditions that may operate as relatively inflexible requirements matching a student to the institution. The institution model will typically include elements such as the institution's location, tuition and fee information, available courses of study, and other pieces of institution data of the sort described immediately above. In the simplest case, the institution model is simply a data structure (e.g., a database) containing structures for each institution and the collected institution data against which student preferences will be compared in order to generate a match. This sort of data structure may take the form of a data table having an institution identifier, and a list of institution data. In other embodiments, the data structure may be a an addressable matrix of data categories (e.g., “locations”, “teaching modalities”, “degrees”), and with each category, a table is provided of individual data points within the category (e.g., a list of physical locations, in-person only, etc.). These sorts of simple models, however, are not required. In other cases, the institution model will be an AI model including a neural network trained on historical data of the sort described below in connection with the objections and subjective AI models.

In an optional and unillustrated step, institutions participating in the system may add one or more “stretch factors” to the institution data included in the institution model. These “stretch factors” are usable to redefine institution data in order to broaden or narrow the matching student pool. These stretch factors may reflect aspirational goals of the institutions, or planned future paths for the institution. By way of example, if an institution plans to open a new campus in the future, or launch a new degree program, an institution user may add data reflecting that future path to the institution data to be included in the institution model. More generally, a participating institution, through an institution facing UI operating on, for example, computing device 135, may be presented with the institution data included in the institution model, and may be given the opportunity to make alterations. For example, an institution may be interested in adjusting GPA cutoffs to broaden the universe of potential matches or may wish to alter the tuition/fees information in expectation that financial aid will be available to some or most students.

In step 215, alumni data from alumni from participating institutions is collected, preferably with the assistance of AIIB 146. As is set forth above, alumni are preferably individuals who have recently successfully completed a degree program at an institution, but this is not a requirement. Individuals who have completed non-degree certifications or other credentials may also be included. Additionally, “alumni data” from unsuccessful former enrollees may also be collected at step 215. Such data from unsuccessful former enrollees may be useful in training the AI models described below. The alumni data includes both objective and subjective sentiment data. The objective data will generally include objective information about the alumni's path through the institution, graduation, post-graduation employment, and demographic factors. Examples of objective alumni data include: race/ethnicity, gender/gender identity, household/family wealth/income at enrollment and at the time of the survey, domicile location at enrollment and at the time of the survey, current salary, time in current job, degree/certifications received, years taken to graduate, whether and the degree of financial aid received, indebtedness at the conclusion of college. In certain cases, alumni demographic data is supplemented by zip-code level demographic data from the alumni's place of residence at the time of survey sourced from third party sources.

Still referring to step 215, alumni are also asked to supply subjective sentiment data regarding their pre-college, college and post-college experiences. This subjective sentiment data may be classified in at least two categories: current sentiments about the college experience, and memories of prospective sentiments about the college experience held by the alumnus prior to entering college. Categories of sentiment data may include sentiments relating to: student support and resources, expectations, quality of instruction, extent and quality of communication, personal health and wellness, the student's sense of community and belonging, the student's sense of validation and respect, financial concerns, student self-actualization and growth, co-curricular development, career preparation, sense of community, family support or concerns, emotional and physical safety, academic rigor, opportunities to advance social/political concerns, opportunities for practicing one's faith and a supporting faith environment, difficulty of college, the degree to which college prepared a person for their career, forming friendships, being connected to other students at the institution, in the student's major, and with faculty mentors, having people to talk to, feeling welcome, feeling valued and the importance of cultural/political/social/athletic activities. Alumni are preferably asked to answer questions in some or all of these categories reflecting what their sentiments were upon enrolling in the institution, and then whether and the degree to which their experiences were positive or negative with respect to those subject matter areas upon exiting. The chart below provides examples of memory-based questions and post-enrollment questions. The memory-based questions, labeled “pre-enrollment sentiments” are also asked of prospective students using the system, and will elicit subjective student data as further described below.

| Pre-enrollment sentiments | Post-enrollment sentiments |
|---|---|
| In addition to your courses, what are some | What were some of the most memorable |
| of the additional experiences you would | activities you participated in as a student? |
| like to have while in college? | |
| How would you describe the ideal faculty | How would you describe the faculty in your |
| at your institution. | major overall? |
| What are your goals in going to college? | How did going to college help you? What |
| How do you hope it will contribute to your | goals did it help you meet? What were some |
| future? | ways it helped you that you hadn't thought |
| | of before? How did your college help you |
| | meet each of your goals? |
| What are your biggest fears about going to | How did you overcome your fears in going |
| college? What are you worried about? | to college? What did the college do to help |
| | you overcome those fears? |
| What are your family's aspirations for you | How does your family feel about you going |
| going to college? What do they hope for | to college? Did your college help allay their |
| you? | fears? |
| On a scale from 1 to 5, how important to | On a scale of 1 to 5, how successful were |
| you is making lasting friendships in | you at making friends in college? |
| college? | |
| On a scale from 1 to 5, how important is it | On a scale from 1 to 5, did you feel like you |
| to you to feel that you belong at college? | belonged at college? |
| On a scale from 1 to 5, how concerned are | On a scale from 1 to 5, did you feel |
| you about your physical safety at college? | physically safe while at college? |

It will be appreciated that subjective alumni data (and the student data to be discussed) may take, and preferably do take, a variety of forms. Some of these data are properly described as sentiment data, such as data reflecting the degree to which (e.g., on a scale) the individual finds a particular experience, value or condition within one of the aforementioned broad topics to be important or valuable. Other subjective data includes identifications of experiential features that an interviewee finds valuable or concerning (e.g., specific fears, experiences, attributes of faculty, cultural offerings). In certain embodiments, interviewees are asked to rank the importance of these experiential features.

Alumni are chosen for participation in providing alumni data to the system according to a number of criteria. Generally, alumni will be selected from a pool of individuals who successfully completed degree programs at the institution, but as set forth above, other criteria such as certification completion may be used. Alumni will generally be given some sort of incentive to participate, such as event tickets, merchandize, or other incentives. In selecting alumni for participation, implementors of the system will preferably select within a demographically representative sample of alumni in an effort to generate alumni data spanning the range across multiple demographic categories. In preferred embodiments, alumni data from unsuccessful previous enrollees is also gathered, as such data may be useful in providing training feedback for the AI models as described below.

In step 220 one or more, and preferably two, alumni models are built. Alumni models include, at least, a first AI model based on objective alumni data and a second AI model based on subjective alumni data, where objective and subjective data are data in the categories just described. The alumni models detect the similarity of a user's answers to questions directed to objective and subjective data to answers provided by alumni to questions within those same categories, in the aggregate. Thus, the first AI model determines the similarity of an input vector of objective data to objective data relating to successful alumni, in the aggregate. The second AI model determines the similarity of an input vector of subjective data to subjective data relating to successful alumni, in the aggregate.

In preferred embodiments, first and second AI models include feed forward artificial neural networks that have been trained on alumni data, in either a supervised or unsupervised manner. It should be appreciated that the first and second AI models can be any suitable neural networks (e.g., Hopfield, Boltzmann, RBM, Stacked Boltzmann, Helmholtz, etc.) trained in an unsupervised manner. In addition, the first and second AI models are not limited to unsupervised neural networks. The first and second AI models can include an artificial neural network (ANN), a convolutional neural network (CNN), a recurrent neural network (RNN), and any other suitable supervised neural networks.

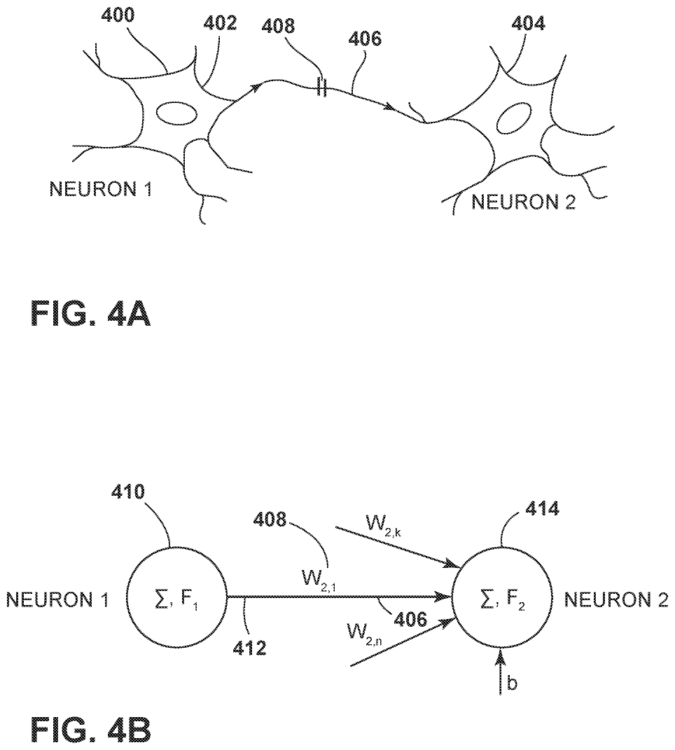

FIGS. 4A and B provide a schematic explanation of ANNs usable as the first and second AI models described above. ANNs are comprised of elements referred to as neurons. Each neuron receives one or more inputs, and produces a single output. At a given time each input is either active or not (e.g. 1 or 0), and the neuron's output is also 1 or 0. Each input to a neuron has a corresponding “weight”, which determines the strength of that input's influence on the neuron. The neuron's overall activation is the sum of all its active inputs, with each scaled by the corresponding weight. The neuron compares this sum (of weighted inputs) to a fixed threshold when deciding whether or not to fire at a given time. The unidirectional connections between neurons are referred to as “synapses” with the output of a pre-synaptic neuron becoming the input of a post-synaptic neuron. Each synapse has a “weight” which determines a pre-synaptic neuron's influence on the post-synaptic neuron: a high weight means that the pre-synaptic neuron can easily cause the post-synaptic neuron to fire; a low weight synapse mean that the pre-synaptic neuron has only a weak influence on the post-synaptic neuron.

Neurons and synapses are collected together into neural networks. An ANN can use this collection of neurons to perform tasks which are difficult to perform with standard computer logic, with examples including pattern recognition.

For both artificial and biological neural networks, the basic unit of computation is individual neurons and their connections. A schematic of a biological neural connection is shown in FIG. 4A. The first neuron 400 emits output signals through its axon 402. The second neuron 404 receives input signals through its dendrites 406. Each time the first neuron 400 emits a signal, that signal is received by the second neuron 404. The intensity of the signal received by the second neuron 404 is determined by the strength (the “weight”) of the synapse 408. The synapse 408 is the connection where the output (axon 402) of the first neuron 400 meets the input (dendrite 406) of the second neuron. The second neuron 404 receives input through one or more dendrites 406, then sums all inputs together, then compares that sum to a threshold to determine if the second neuron is sufficiently activated to emit its own output (i.e. if it “fires”). An essential feature of biological neural networks is the ability to adjust the weight of each synapse 408. Adjusting of synaptic weights is a biological underpinning of learning.

ANN's replicate the behavior of the biological model described in FIG. 4A. An abstracted schematic of an artificial neural connection is shown in FIG. 4B. In this schematic, the first neuron 410 takes the sum Σ of its input and passes this sum through a thresholding function f1 to determine its output on the outgoing axon 412. A neuron's output is either “fire” or nothing; there is no partial output from a neuron, all outputs are the same. This signal is received by the dendrite 406 of the second neuron 414. At each axon-dendrite connection, there is a synapse 408 with a particular synaptic weight w. This weight may be understood in some cases to be the relative importance of each input on the second neuron 414.

Each neuron has a threshold that must be met to activate the neuron, causing it to “fire.” The threshold is modeled with the transfer function, f. Neurons can be fall into two categories; the first is that they can be excitatory, causing other neurons to fire when they are stimulated. The second is that they can be inhibitory, preventing other neurons from firing when they are stimulated. Excitatory neurons may be modeled as having positive synaptic weights on their outgoing synapses, while inhibitory neurons may be modeled as having negative synaptic weights on their outgoing synapses.

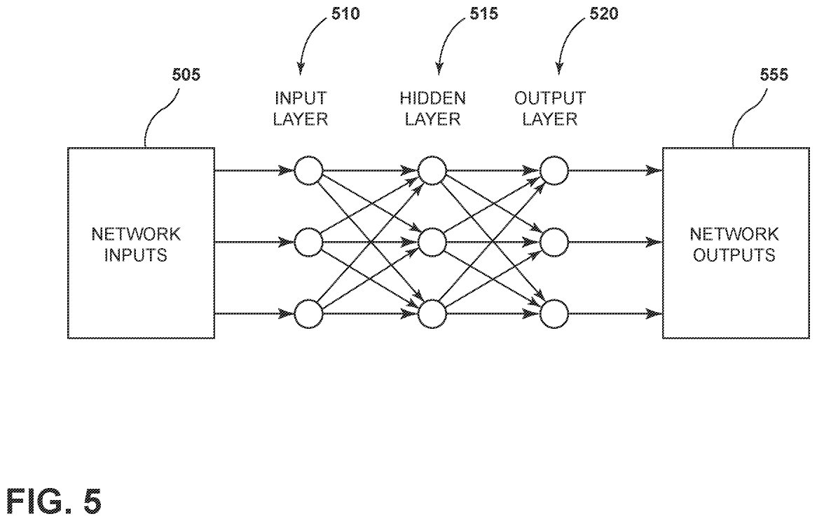

One form of an ANN uses “layers” of neurons as depicted in FIG. 5. An input layer 510 receives direct inputs 505 (e.g., a vector or an ordered sequence of binary bits) from external data. An output layer 520 produces the ANN's final output 525, it's “decision” (e.g. a sequence of binary values used to compute a match index). Zero or more hidden layers 515 between the input and output layers perform intermediate calculations. Each connection (each arrow) between neurons has a synaptic weight, a scalar value which determines the influence of each input on the post-synaptic neuron.

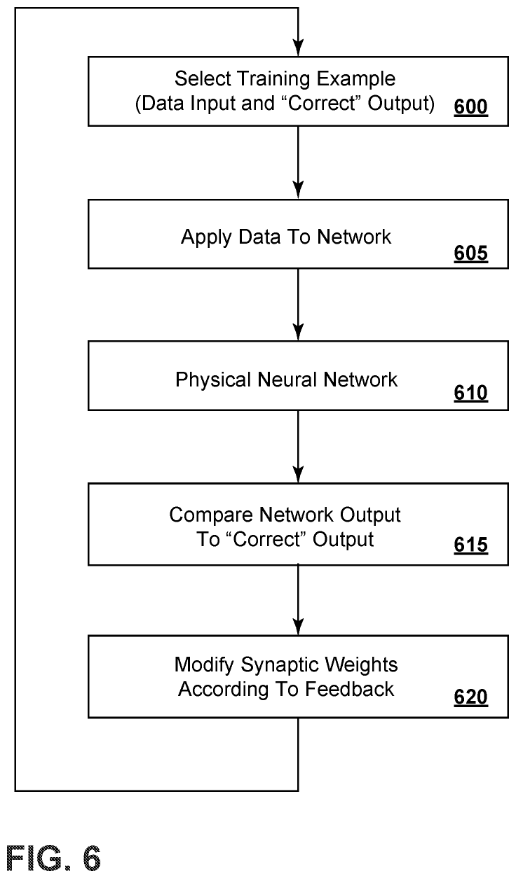

The process of “training” a neural network generally involves a repeated process of adjusting synaptic weights. An ANN of the sort usable herein for the first and second AI model may be trained by a process of “supervised learning”, wherein the network is supplied with labeled examples of objective and subjective data from successful alumni, or some other collection of individuals sought by an institution. The network learns to map from inputs (e.g. vectors of objective and subjective data) to outputs (e.g. output vectors indicating success) by a trial-and-error process of adjusting the synaptic weights between neurons throughout the layers of the ANN. After an initial default (“blank”) setting of the synaptic weights, the training process involves several steps as shown in FIG. 6. An example set of alumni data is drawn from a training data set (600). The data is applied to the ANN “input layer” (605). The “input layer” then drives its output into zero or more “hidden layers”, which drive output into the “output layer” of the ANN (610). The ANN output is compared to some predetermined output value indicating “success” on the part of the alumnus to assess whether the ANN is “correct” (615). Then, the synapses are modified based on this feedback 620, e.g. by rules such as “if the output is correct then the participating synapses are strengthened; if the output is incorrect then the participating synapses are weakened”. These rules may be inverted in cases where the model is being trained on unsuccessful alumni data. This sequence of steps may be repeated multiple times with multiple examples of alumni data to train the ANN. Synaptic weights may be adjusted many times in the process of training an ANN, and when training is complete the “knowledge” of the ANN is contained in the synaptic weights (in combination with the layout of the network, but the layout is not changed).

In preferred embodiments, first and second AI models are ANNs trained according to the methodology above that are entirely software-based, in that the neurons, synapses, and weights exist entirely as digital values subject to mathematical operations on standard computing hardware (e.g., computing device 110). In these cases, the models themselves, including the layout of neurons, synapses and synaptic weights are stored in the memory 120.

Referring again to FIG. 2, in the model building process of step 220, objective alumni data is presented as an input vector to a multilayer feed-forward ANN of the sort described above in relation to FIGS. 5-6, for training purposes. This may be done in a variety ways. In the simplest case, all objective data are encoded to a bitstream of binary numbers, which serve as direct inputs to the neural network. In certain cases, as with data that indicates the presence or absence of some feature (e.g., some experience or cultural offering) the position of the data in the input vector and a binary value (1 for the presence of the feature and 0 for its absence) may be used for encoding. In other cases, the encoded number may reflect some non-binary value (e.g., the strength of a preference, zip code, or a number reflecting income quintile).

During the training process, synapse weights (and optionally, firing thresholds) within the neural fabric may be initially random or equal. Alumni data are presented as inputs to the network, and the output values are combined in some say (e.g., by averaging or simple summation). The network is trained by providing feedback tending to force the network to return large output values (on average or in the aggregate) in response to alumni input data from successful alumni. Results are improved by incorporating analogous data inputs from unsuccessful alumni, which are used to provide negative feedback. This training process is used to build the first AI model (on the basis of objective alumni data) and the second AI model (on the basis of subjective alumni data).

In preferred embodiments, each of the first and second AI models may include sub-models. For example, second AI model may include sub-models that have been built with subjective data from alumni within predefined demographic categories or slices (e.g., family income quintile, race, gender, or type of degree obtained). These sub models will then be applied to subjective student data from students with matching demographic profiles to generate a subjective matching scores on data from demographically similar alumni. Additionally, at least one second AI model is built on the basis data about alumni's recollections of their pre-enrollment values and priorities (the pre-enrollment data), which rely on an alumnus's recollection of their sentiments about various topics when they entered college. As is set forth above, alumni data may also include post-enrollment alumni sentiments that are retrospective, in particular, sentiments about what their college experience was actually like. In one alternative, data from both these groups is used to train the AI models, e.g., the second AI model. In these cases, alumni response data is grouped by topic and aggregated (e.g., if an alumnus entered college placing great importance on making friends, and actually made good friends in college), the weight of training value corresponding to this datum is increased. In cases where the alumni responses indicate that the college was not successful in meeting the value held by the alumnus pre-enrollment, the value of the input corresponding to that topic may be decreased.

In other examples, the second AI models are built using only the retrospective data, in which case, the alumni data need not include memory-based recollections of priorities upon entering college at all. In these cases, the value of inputs by data category are encoded to reflect the degree of success that an institution had in satisfying the alumnus on some subject. For example, alumni data may include a sentiment datum indicting the degree to which the alumnus felt as if she “belonged” at an institution. The training input vectors will reflect this result by having some value at a position in the vector corresponding to the “belonging” question, with a higher value reflecting the alumnus' feeling (or sentiment) that the institution was successful at providing this. Repeated training vectors with high values at this position, from successful alumni, will reinforce the weight the model gives this factor. When student sentiment data is later applied to the model, the student data is formatted so the student's answer to a question concerning the importance of “belonging” will be fed into the network at the same position as the corresponding alumni data on the related question, and in this example, that answer will be given relatively higher weight in the overall matching score produced by the model. In this way, the models are built to increase the likelihood of a match on issues that prospective students feel strongly about, and on which the university has produced positive results for alumni in the past.

FIG. 3 is a conceptual block diagram of a student matching process implemented by an embodying system. The process of FIG. 3 may be run after computing device 110 has already build the institutions model, and the first and second AI models (objective and subjective) that are described above in reference to FIG. 2. According to the process of FIG. 3, in step 305, prospective student data (“student data”) is received, for example, through the student facing UI described above in connection with FIG. 1. Student data may include data received directly from the student, or data from third party sources (e.g., a student's FAFSA, transcripts, standardized test companies, etc.). As is set forth above, student data has both objective, including demographic, and subjective components. Objective data include demographic data, and also student requirement about institutions, such as desired (or required) location, size, degree programs offered, GPA, and test scores. Student data also includes subjective data elicited by the AIIB describe in connection with FIG. 1, above, which generally, includes student sentiments on values, experiences and subjective conditions associated with a college experience. As with the subjective alumni data described above, categories of subjective student data may include sentiments relating to: student support and resources, expectations, quality of instruction, extent and quality of communication, personal health and wellness, the student's sense of community and belonging, the student's sense of validation and respect, financial concerns, student self-actualization and growth, co-curricular development, career preparation, community, family support or concerns, emotional and physical safety, academic rigor, opportunities to advance social/political concerns, opportunities for practicing one's faith and a supporting faith environment, difficulty of college, the degree to which college prepared a person for their career, forming friendships, being connected to other students at the institution, in the student's major, and with faculty mentors, having people to talk to, feeling welcome, feeling valued and the importance of cultural/political/social/athletic activities, building connections with demographically similar people (e.g., ethnically similar people), indigenous or other cultural values, etc. As with the subjective alumni data described above, subjective student data may be binary (“wants a school with a Division 1 athletic program”) or nonbinary (“I value the opportunity to form lasting friendships a 3 on a scale of 5”).

Referring now to step 310, the student data is processed to separate it into categories, which will include: inflexible requirements, objective student data (primarily demographic data) and subjective student data including sentiment data. The inflexible requirements student data includes student preference data that may be used to categorically exclude some institutions on the basis of, for example, price, selectivity, location or the availability or non-availability of certain degree programs. In step 310, the inflexible requirement student data are applied to the institutions model to filter out institutions that are outside the criteria established by the inflexible requirements. The result of this process is an initial match between a student and one or more institutions on the basis of only the most fundamental criteria (e.g., location, price, selectivity, degree programs). As is described below, this sort of basic of tier 1 match may be provided to students who have a first level of engagement with the system, for example, students who are using the system for free.

Referring now to step 315, objective student data, including demographic data, is applied to each institution's first AI model, which has been trained with objective alumni data. In this step, and in step 320 below, the models being used are preferably models for institutions that remain in contention (i.e., were not filtered out) by application of the institutions models described above. The result of this process is an objective matching index, for each institution model, that reflects a degree of similarity between the student and successful alumni for that institution on the basis of objective data (e.g., chosen major, grades, gpa, personal and family background, personal and family finances, etc.). In cases where the first AI model is a neural network, the matching index may be calculated as a combination of network outputs, for example, a summation of outputs, a numerical value expressed by the output bits in binary, or an average. The system may declare a student to be matched to an institution when the combination of network outputs exceeds some predetermined threshold. In certain cases, multiple matching thresholds may be applied, and the system may take different actions as a result. For example, certain institutions for which the matching index exceeds a first threshold may be classified as a “strong match”, a next group of institutions that exceed a second, lower threshold, but not the first threshold may be classified as “possible matches”. Information about these different groupings may be presented to the student in a report that differentiates the institutions on the basis of the match. Additionally, different levels of information may be provided to the student on the basis of the student's level of interaction with the system (e.g., subscription level). For example, the system may present only some of the strong matches to free users, while all matches will be presented to paid subscribers. Various subscription tiers, which are described below, are applicable to all embodiments discussed herein.

In alternative embodiments, matches may be declared on the basis of high values on certain output nodes of the First AI model, indicating a strong match on certain features. For example, certain output positions of the First AI model for some institutions may return high values for students having relatively low GPA or test scores (e.g., less selective institutions). In such cases, reports may be generated and provided to the student showing which institutions matched strongly on which student factors. Again, this sort of more granular information may be reserved for certain users, such as paid subscribers or paid subscribers at some subscription level. Institutions may use these features to hunt for specific sorts of students who match on only a handful of qualities.

Referring now to step 320, the subjective student data, including the sentiment data that has been previously described, is applied to each institution's second AI model, which has been trained with subjective alumni data. The result of this process is a subjective matching index, for each institution's second AI model, that reflects a degree of similarity between the student and successful alumni for that institution on the basis of subjective data (e.g., the importance of certain values, experiences an emotional concerns). In cases where the second AI model is a neural network, the matching index may be calculated as a combination of network outputs, for example, a summation of outputs or a numerical value derived from the output bitstream. The system may declare a student to be matched to an institution when the combination of network outputs exceeds some predetermined threshold. In certain cases, multiple matching thresholds may be applied, and the system may take different actions as a result. For example, certain institutions for which the matching index exceeds a first threshold may be classified as a “strong match”, a next group of institutions that exceed a second, lower threshold, but not the first threshold may be classified as “possible matches”. Information about these different groupings may be presented to the student in a report that differentiates the institutions on the basis of the match. Additionally, different levels of information may be provided to the student on the basis of the student's level of interaction with the system (e.g., subscription level). For example, the system may present only some of the strong matches to free users, while all matches will be presented to paid subscribers. Various subscription tiers, which are described below, are applicable to all embodiments discussed herein.

The matching indices from the first and second AI models may be used, alone or in combination, in various ways, to match students to institutions (step 325). As is set forth above, a subset of institutions is selected on the basis of inflexible criteria in step 310, and for this subset, first and second AI models are applied to the objective and subjective student data (steps 315 and 320). The result of this process is a series of first and second matching indices for each institution. The possibility exists that some schools with have high matching indices on objective criteria, but low matching indices on subjective criteria or vice versa. In one embodiment, the system finds a match between a student and an institution if both the first and second indices are above some threshold. In other embodiments, a match is determined when either is above threshold. In another embodiment, the first and second matching indices are combined in some way (e.g., summation or averaging) and a combination matching index is thus generated and applied to one or more thresholds. In a preferred embodiment, one or more of these matching methods is applied, and the student is given a report showing which institutions matched, and on what basis. The granularity of this report, showing specific matching categories, again, may be determined by the student's subscription level.

As is set forth above, in preferred embodiments, subjective matching is performed on sub-models that have been sliced by alumni demographic characteristics, like socio-economic status, degree or degree type, or race/ethnicity/gender. In these embodiments, the method of FIG. 3 includes a steps of classifying the student according to a socio-economic slice category, retrieving the 2nd AI sub-model corresponding to that category, and for each institution in contention, then computing subjective match indices from that sub-model. The system in these embodiments otherwise operates as described above. Slicing the student and alumni data by demographic category provides the system with the ability to match students to institutions that produced successful outcomes for demographically similar students.

As is suggested above, when matches are detected according to the method of FIG. 3, the system may take one or more actions. One such action is to send an indication of one or more matches to the student, for example, as an ordered list of providers ranked according to degree of match. As another example, the system may prompt an ad server (an application process run by processor 112) to send the student an advertisement for a matched provider or media content (using an unillustrated media content server) regarding the matched provider. The ad server may also be used to generate ads served to various web services (e.g., YouTube and social media pages) to display ads for the system and providing links to the system that can be used for enrollment. As another example, the system may prompt a lead generation server to generate a lead message to send to the student 130 indicating a match with a student. The lead may include identifying information about the student, allowing the provider to contact the student directly, or it may be anonymized. In the case where the data is anonymized, the system may support anonymized communication between the student and the institution, for example, through a non-illustrated email, sms or other messaging server.

As is suggested above, the system, or institutions matched to a student by the system, provide the student with interactive reports and other information about the matched institutions. The detail of these reports may vary depending on whether the student, the institution or both is a subscriber, the level of subscription and the degree of match (i.e., whether the student matched on the basis of inflexible criteria and institution data, objective alumni data or subjective alumni plus objective alumni data). When the a student and institution match under the first phase of matching, the student may be sent a first level of report, which contains information on or more institutions, and which allow the student to review, compare, and select potential postsecondary providers based provider and relevant third data. Such data may include basic institution information such as Programs of study, Length of Programs, Number of credits the student will likely transfer in, Number of credits they will likely provide as Credit for Prior Learning, Program Modality, Completion Rates, Net Cost after Financial Aid, Expected Loan Debt, Expected Monthly Payment on Loan Debt, Probability of defaulting on a loan, Types of Jobs the Program will prepare them for, List of such jobs currently available in a specified region, Median earnings at 1-year, 3-year, 10-years after earning degree or credential, Number of years to recoup investment (calculated under the Equitable Postsec Value Framework).

In some embodiments, information provided to prospective students and to participating postsecondary service providers would be further personalized by the system when provided access to the following data (some of it publicly available, other proprietary in need of data sharing agreement) by the postsecondary service provider: Program catalog (credit, no-credit, degrees, certificates), Admissions requirements, Disaggregated Selectivity Data, Tuition and Fee schedules, Total Cost of Attendance, Institutional financial aid structure, and a Predictive Analytics (Student success prediction based on the degree of match with the institution).

It is contemplated that embodying systems will provide different levels of service to users as a function of, for example, a subscription level. Different levels of service may be defined in terms of the data sources that are accessible in running the matching algorithm (e.g., a higher subscription level may allow a student to access or have matches computed on the basis of proprietary provider data rather than just public data), the degree of communication between providers and students supported, or the sorts of offers available from providers. In particular, different levels of student data may be received from the student depending on the subscription/service level selected. In certain cases, a higher level of subscription may enable matches computed on the basis of objective alumni data, and yet a higher level of subscription on the basis of subjective alumni data. Examples of varying levels of service that may be supported will now be described.

In a first example, it is contemplated that a student may enter a first level of student data, referred to herein as the BASIC level. In this embodiment of the invention, a prospective student searches for postsecondary programs using their web search engine of choice. The prospective student clicks on a search result or advertisement pointing to the system platform and is routed to the corresponding intake portal. Alternatively, a prospective student can navigate directly to the system platform through a direct-marketed lead from the service or by scanning a QR-Code from an advertisement presented in print or online media. The prospective student then explores various free services available to them which require creating an account and providing basic information (e.g., highest educational level reached, preferred learning modality, budget constraints, place and time-bound constraints. employment status, career interests). The system will then use this information to package a lead to service providers who may be interested in reaching out to the prospect. This would be one of the more affordable leads for service providers as the information is basic (but more than they typically get from direct online marketing and in-person recruitment drives) and they will have to invest additional efforts in converting the prospect's interest into an accepted offer of enrollment.

In addition to the potential ads from interested postsecondary service providers, prospective students may optionally receive a curated list of possible matches identified by system on the basis of basic student data and basic institution, which they may opt to pursue further. This curated list may be based on the first phase matching step (310) described in connection with FIG. 3. In this case, the system may monetize interaction with it by tracking whether the prospective student reaches out to one or more of the results presented to them, and then collecting payment from the selected service provider. In developing this curated list, the platform may alternatively use the prospect's basic information in searching through myriad public and private databases and present the prospect with a curated list with basic information on each of the potential service providers, including information such as: programs that match prospect's interest, length of programs, modality in which they are offered, the overall completion rate of students enrolled in the program, the average net cost, average debt levels, average loan default rates, availability of relevant jobs for which the program is well-aligned (by region), average annual compensation in those jobs, and the expected return on investment over time. This information could be enhanced by having live links to job openings that require said degree or credential and relevant labor-market data.

A second level of information, referred to herein as BASIC+, a more personalized experience is provided. In such embodiments, a prospective student, once they have navigated to the system platform, creates an account and provides an additional layer of information, referred to as basic+ information. The basic+ information would include the basic information described above, plus personal demographic information like race, ethnicity, and income levels; information relating to their educational journey like whether they are first-time postsecondary-seeking students just out of high-school or having obtained a GED, have some postsecondary education but no degree, or already have one or more degrees or credentials; financial aid eligibility information like whether they still have access to Pell grant funding, state funding programs, employer tuition assistance programs, etc.; information on employment history, perhaps permission to access their LinkedIn profile to get a sense of potential for Credit for Prior Learning information. The system may process this information for application to the second AI model to match against objective alumni information, and to generate institution matches based on that information.

The system can then use this information to package a lead to service institutions who may be interested in reaching out to the prospect. This would be a more valuable lead for service providers as the information will allow them to make a better analysis of the student that could perhaps lead to conditional admissions offer subject to additional contact. In addition to the potential ads and/or conditional admissions offers from interested postsecondary service providers, prospective students would get a curated list of possible matches identified by system they may opt to pursue further. The list could be presented with a relevance score alongside sponsored options, but user would be invited to dig deeper. In this case, the monetization depends on whether the prospective student reaches out to one or more of the results presented to them.

As above, in developing this curated list of matches, the platform would, in one aspect, use the prospect's basic+(enhanced) information in searching through myriad public and private databases and present the prospect with a curated list with basic information on each of the potential service providers, including information such as: programs that match prospect's interest, length of programs, modality in which they are offered, the average completion rate of students enrolled in the program who had similar characteristics to the prospective student (e.g., graduation rates tend to be lower at some institutions for students from historically underrepresent and underserved groups), the average net cost for students in similar economic circumstances, average debt levels for similar type of students, average loan default rates for similar types of students, availability of relevant jobs for which the program is well-aligned (by region), average annual compensation in those jobs, and the expected return on investment over time. This information could be enhanced by having live links to job openings that require said degree or credential and relevant labor-market data.

In yet another embodiment of the invention, a prospective student, once they have navigated to the system platform, may create an account and provide premium information (e.g., basic+ information as described above, plus educational transcripts or permission to request them on their behalf, certificates and badges earned, interest in a Credit for Prior Learning evaluation, income levels and permission to help with filing their FAFSA, and demographic descriptors like first generation student, justice impacted student, undocumented or DACA student, etc.). At this level, the system can optionally gather the sentiment and other subjective student information described above using the ABB The system then applies this information to the second AI model to match with institutions on the basis of sentiment and other subjective factors as described above. The resulting matchings are used by the system to package leads service providers who may be interested in reaching out to the prospect. This would be the most valuable lead for service providers as the information will allow them to make a better analysis of the student that could perhaps lead to complete admissions offer with financial aid packages subject to additional contact. In addition to the potential ads and/or conditional admissions offers from interested postsecondary service providers, prospective students would get a curated list of possible matches identified by system they may opt to pursue further. In this case, the monetization depends on whether the prospective student reaches out to one or more of the results presented to them.

When an institution strongly matches to a potential student, particularly on subjective alumni factors, the institution may want to reach out to the student to provide an admission or informational interview. In certain embodiments, when requested by an institution, the system may identify to the institution one or more institution alumni having an objective or subjective profile that closely matches a student. This information could be used by the institution to set up an interview. Additionally, or alternatively, the system could provide the student with contact information of institution alumni that closely match the student. In such circumstances, the system may support a text or video chat facility between the alumnus and the student, which may be anonymous as to one or both parties. In certain embodiments, the interactive report provided to students using the system at the highest subscription level may include alumni profiles for institutions for alumni who closely match the student on objective or subjective factors. These profiles may be anonymous, but preferably are not.

It will be appreciated that what has been described is an improvement in previous matching systems by incorporating the use of AI models trained with alumni data to gauge similarity between applicants and successful alumni on the basis of objective and subjective characteristics. These models may be improved by tracking objective and especially subjective student data from students during their course of study through, and for some year after, graduation. In these cases, the AI models are periodically given training updates on the basis of in-process student data, in the same categories as the initially supplied student data, and is used to train the AI models on a rolling basis or other trigger such as changes in institutional program and service offerings, mergers, etc.

It will be further appreciated that the systems and methods described herein may be extended beyond the post-secondary education service provider environment to other environments in which the matching of individuals to positions on the basis of objective and subjective criteria is desirable. For example, the methods and systems described herein can be easily adapted to matching candidates to employment positions. Indeed, in one modified aspect of the invention, the system matches students already enrolled to employers, in a process that may be used by institution job placement offices.

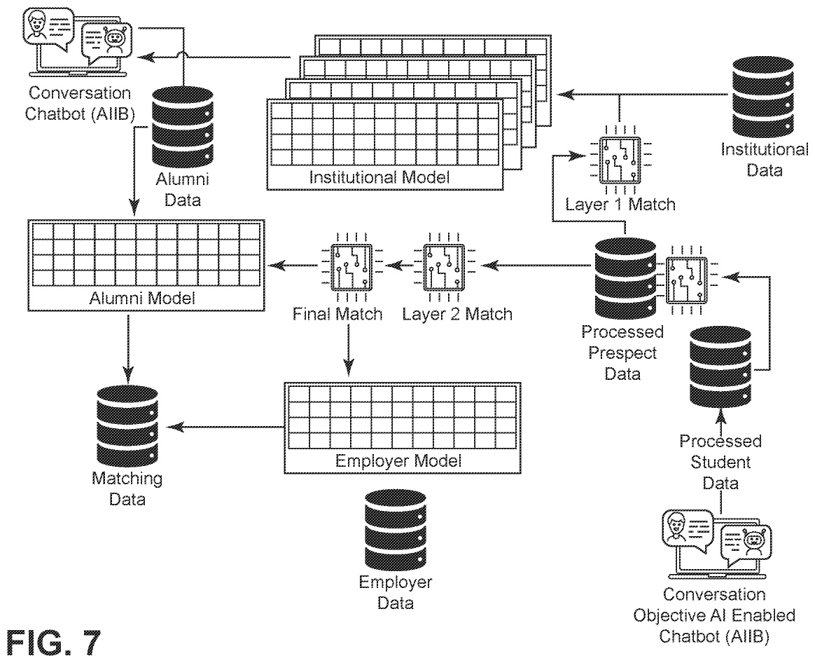

A schematic arrangement of an embodying system including employer matching is depicted in FIG. 7. According to the arrangement of FIG. 7, and referring again to FIGS. 2 and 3, additional matching is performed on the basis of employer data. The employer data may be in the same general categories as the institution data discussed above: certain inflexible data points (location, broad salary range, travel requirements, degrees and expertise required, etc.). The employer data may also include objective data gathered from employees—preferably alumni of participating institutions. These objective employee data may include demographic information, time on the job, educational background, salary history, etc. Additionally, the employer data may include subjective employee data such as sentiment data about experiences and values at the employer. These data may include things like the degree of felt-belonging, the employer's commitment to diversity, etc. At least the objective and subjective employee data may be used to build additional AI models to detect similarity with employees on the objective and subjective measures, in the aggregate. This process may involve neural network training of the sort discussed above.

As in the systems above, the student, preferably a student at the institution, is asked to provide student data, which may be supplemented by objective sources of student data (i.e., from the institution's registrar's office). This student data includes objective data (demographic, grades, major), and subjective and sentiment data, as above. The student also may supply hard criteria like location, salary range, etc.

In a first phase of matching, student inflexible requirements (location, job for which my degree qualifies me) is applied to an employer model to filter out employers with jobs that are not-suitable on inflexible criteria. In a second process, a first matching index is generated by applying the objective student data to the first AI model, thereby matching student objective data (mostly demographics) to employers on the basis of similarity with objective data from those employers' employees. In a third matching process, a second matching index is generated by applying the student subjective data to the second AI model to match to employees on sentiment. Matches may then be identified between students and employers according to the methods discussed above.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

1. A method for displaying matches between an institution and a prospective student, the method comprising:
causing a first user interface to be presented to a prospective student of the institution via a first computing device, the first user interface employing an artificial intelligence interview bot configured to elicit inflexible institution criteria, objective student data about the prospective student and subjective student data about the prospective student's sentiments toward values and experiences relating to the institution;
receiving institution data over a network;
building an institution model from the institution data, the institution model reflecting objective institution data, and applying the inflexible institution criteria to the institution model, and on the basis of the application, qualifying the institution for a possible match;
in a first matching process, using a first AI model including an artificial neural network to determine the similarity of the objective student data to objective alumni data previously received from successful alumni of the institution, and on the basis of the determined similarity, computing an objective matching index;
in a second matching process, using a second AI model including an artificial neural network determine the similarity of the subjective student data with subjective alumni information previously received from successful alumni of the institution, and on the basis of the determined similarity, computing a subjective matching index;
applying a match criteria to the subjective and objective matching indices, and determining whether the student is a match to the institution on the basis of the application, and
if the student is a match to the institution, causing the first user interface to display an indication of the match to the prospective student.

2. The method of claim 1, further comprising:
causing a second user interface to be presented to a successful alumnus of the institution via a second computing device, the second user interface employing an artificial intelligence interview bot configured to elicit and receive objective alumnus data about the alumnus and subjective alumnus data about the alumnus' sentiments toward values and experiences relating to the alumnus' attendance at the institution.

3. The method of claim 2, further comprising training the first AI model with one or more training data sets derived from the objective alumnus data, and training the second AI model with one or more training data sets derived from the subjective alumnus data; wherein determining the similarity of the objective student data to objective alumni data previously received from successful alumni of the institution comprises supplying objective student data to the first trained AI model, and wherein determine the similarity of the subjective student data to subjective alumni data previously received from successful alumni of the institution comprises supplying subjective student data to the second trained AI model.

4. The method of claim 1, wherein the objective student data includes information regarding a demographic profile of the prospective student, and wherein objective alumni data includes information regarding demographics of successful alumni.

5. The method of claim 4, wherein the second AI model includes a plurality of sub-models, each sub-model including an artificial neural network trained on subjective alumni data received from alumni within a predetermined demographic category, and wherein the second matching process includes determining a demographic category for the prospective student, and applying the subjective student data to a sub-model corresponding to alumni of the prospective student's demographic category.

6. The method of claim 5, wherein the predetermined demographic category relates to one or more of race, gender, income, wealth, and degree field.

7. The method of claim 1, wherein subjective student data includes prospective student sentiments regarding one or more of student support and resources, expectations, quality of instruction, extent and quality of communication, personal health and wellness, the student's sense of community and belonging, the student's sense of validation and respect, financial concerns, student self-actualization and growth, co-curricular development, career preparation, sense of community, family support or concerns, emotional and physical safety, academic rigor, opportunities to advance social/political concerns, opportunities for practicing one's faith and a supporting faith environment, difficulty of college, the degree to which college prepared a person for their career, forming friendships, being connected to other students at the institution, in the student's major, and with faculty mentors, having people to talk to, feeling welcome, feeling valued and the importance of cultural/political/social/athletic activities.

8. The method of claim 1, wherein the inflexible institution criteria include one or more of student requirements regarding price, location, size, admissions selectivity and the availability of certain degree programs and the institution data includes one or more data regarding institution price, location, size, admissions selectivity and the availability of certain degree programs.

9. The method of claim 1, wherein building an institution model comprises causing an institution user interface to be presented an institution via an institution computing device, the institution user interface presenting data about the institution to be included in the institution model by default, and providing the institution with the opportunity to alter the data about the institution to be included in the institution model.

10. The method of claim 1, wherein applying a match criteria to the subjective and objective matching indices, and determining whether the student is a match to the institution on the basis of the application comprises determining that a student matches an institution if both the objective and subjective matching indices are above predetermined thresholds.

11. A computerized system for determining and displaying matches between an institution and a prospective student, the system comprising a first computing device having a programmable processor and computer readable instructions encoded in a memory, the computable readable instructions being executable by the programmable processor and operable to cause the first computing device to:
generate a prospective student user interface at a prospective student computing device, the first user interface employing an artificial intelligence interview bot configured to elicit, from a prospective student, inflexible institution criteria, objective student data about the prospective student and subjective student data about the prospective student's sentiments toward values and experiences relating to the institution;
receive institution data over a network;
build an institution model from the institution data, the institution model reflecting objective institution data, and apply the inflexible institution criteria to the institution model, and on the basis of the application, qualify the institution for a possible match;
in a first matching process, use a first AI model encoded in the memory, the first AI model including an artificial neural network to determine the similarity of the objective student data to objective alumni data previously received from successful alumni of the institution, and on the basis of the determined similarity, compute an objective matching index;
in a second matching process, use a second AI model encoded in the memory, the second AI model including an artificial neural network determine the similarity of the subjective student data with subjective alumni information previously received from successful alumni of the institution, and on the basis of the determined similarity, compute a subjective matching index;
apply a match criteria to the subjective and objective matching indices, and determine whether the student is a match to the institution on the basis of the application, and
if the student is a match to the institution, causing the prospective student user interface to display an indication of the match to the prospective student.

12. The system of claim 11, wherein the computer readable instructions are further operable to cause the first computing device to:
cause an alumni user interface to be presented to a successful alumnus of the institution via an alumni computing device, the second user interface employing an artificial intelligence interview bot configured to elicit, receive and transmit to the computing device objective alumnus data about the alumnus and subjective alumnus data about the alumnus' sentiments toward values and experiences relating to the alumnus' attendance at the institution.

13. The system of claim 11, wherein the first AI model has been trained with one or more training data sets derived from the objective alumnus data, and the second AI model has been trained with one or more training data sets derived from the subjective alumnus data; and wherein the first computing device determines the similarity of the objective student data to objective alumni data previously received from successful alumni of the institution by supplying objective student data to the first trained AI model, and wherein the first computing device determines the similarity of the subjective student data to subjective alumni data previously received from successful alumni of the institution by supplying subjective student data to the second trained AI model.

14. The system of claim 11, wherein the objective student data includes information regarding a demographic profile of the prospective student, and wherein objective alumni data includes information regarding demographics of successful alumni.

15. The system of claim 14, wherein the second AI model includes a plurality of sub-models, each sub-model including an artificial neural network trained on subjective alumni data received from alumni within a predetermined demographic category, and wherein the second matching process includes determining a demographic category for the prospective student, and applying the subjective student data to a sub-model corresponding to alumni of the prospective student's demographic category.

16. The system of claim 15, wherein the predetermined demographic category relates to one or more of race, gender, income, wealth, and degree field.

17. The system of claim 11, wherein subjective student data includes prospective student sentiments regarding one or more of student support and resources, expectations, quality of instruction, extent and quality of communication, personal health and wellness, the student's sense of community and belonging, the student's sense of validation and respect, financial concerns, student self-actualization and growth, co-curricular development, career preparation, sense of community, family support or concerns, emotional and physical safety, academic rigor, opportunities to advance social/political concerns, opportunities for practicing one's faith and a supporting faith environment, difficulty of college, the degree to which college prepared a person for their career, forming friendships, being connected to other students at the institution, in the student's major, and with faculty mentors, having people to talk to, feeling welcome, feeling valued and the importance of cultural/political/social/athletic activities.

18. The system of claim 11, wherein the inflexible institution criteria include one or more of student requirements regarding price, location, size, admissions selectivity and the availability of certain degree programs and the institution data includes one or more data regarding institution price, location, size, admissions selectivity and the availability of certain degree programs.

19. The system of claim 11, wherein building an institution model comprises causing an institution user interface to be presented an institution via an institution computing device, the institution user interface presenting data about the institution to be included in the institution model by default, and providing the institution with the opportunity to alter the data about the institution to be included in the institution model.

20. The system of claim 11, wherein applying a match criteria to the subjective and objective matching indices, and determining whether the student is a match to the institution on the basis of the application comprises determining that a student matches an institution if both the objective and subjective matching indices are above predetermined thresholds.
